(19) United States
(12) Patent Application Publication
(10) Pub. No.: US 2012/0074652 A1
(43) Pub. Date: Mar. 29, 2012

(54) Delayed Curing Rubber Composition and Method

(76) Inventors: Jinrong Wang, Tianjin (CN); Zhi Fang Zhao, Tianjin (CN)

(21) Appl. No.: 12/891,640

(22) Filed: Sep. 27, 2010

(51) Int. Cl. F16L 13/00; C08K 3/08; C08K 5/10; F16J 15/10

(52) U.S. Cl. 277/314; 277/316; 277/650; 524/439; 524/297

(57) ABSTRACT

A nitrile rubber based sealant system including seals a made from a unique delayed curing nitrite rubber composition. The composition has excellent storage ability in dry form which can be cured (vulcanized) as needed under and with the aid of varying field conditions. The seals provide superior leak seal suitable for sealing leaks in pipes, fittings, flanges and other structures and are made by heating delayed self curing nitrile rubber formulation comprised of a critically selected combination of components including specially preconditioned nitrile rubber, sulfur, accelerants, activators, fillers, plasticizers, flame retardant, antidegradant, metallic filaments and optionally, nanophase rare earth material. The invention is also a method of sealing leaking pipes, fittings and structures in which the composition is injected (extruded) into heated molds, where it is vulcanized (cured) without further additives, to form a hard, strong, durable chemical resistant seal that can be used to seal leaking pipes and structures without interruptions of flow or shut down of operations. The formulation has the advantage of wide temperature adaptability, wide medium resistance, injection manufacturability with excellent filling quality and sealing ability.

### FIELD OF THE INVENTION

This invention relates to molded polymeric seals and delayed curing compositions for make such seals. More specifically, it relates to a nitrile rubber delayed curing (vulcanizing) formulation or composition, seals made from the formulation and methods of making the seals. The composition is stable and storable until heated to initiate curing.

### BACKGROUND

There exist a continuing need for industrial sealant systems that will perform well with all kinds of industrial media and under adverse conditions. Industrial leaks frequently result in emergencies due to the toxic or explosive effects of the leaks. On-line leak sealing technology is widely used in companies with continual producing process, where unexpected leaks may cause an emergent shutdown and bring enormous loss. With on-line leak sealing technology, the leaks, which are normally found at flanges, tees, elbows, valves, pipelines, and other welded joints need to be stopped quickly and efficiently without affecting the producing process. But, it is often extremely difficult to seal off a pipe leak in the field and particularly difficult to do so without discontinuing the flow of leaking medium.

The economic benefits on-line leak sealing technology effective industrial operations are many and sinificant. By solving the leaking problem while keeping an industrial plant on-line, the plant is saved from unscheduled shutdown, which is a can be costly. Instead of replacing leaking equipment with a new one, an expensive and time-consuming solution, on-line leak sealing technology allows repair of equipment while maintaining system integrity, extending the life of the equipment components. It also protects the environment from noise and harmful emissions and avoids explosion caused by leaking combustible media.

Many commercial pipe leak sealing systems utilize fiberglass wraps with two part epoxy systems and frequently cannot be used without shutting off media flow to suspend the leak while repairs are made. Some other commercial leak systems require application (injection) of two part sealant and often with mixtures of catalysts, fillers and the like. Other repair systems use special enclosures for the leaking pipe section (or equipment section) into which is injected epoxy or two part elastomeric sealants. These two part systems sealant are not totally satisfactory. Moreover, many leaking system are in pipe or equipment at high pressure and temperature and contain chemicals and/or other medium that destroy or weaken conventional sealants. It would be very beneficial to have an easily stored leak sealant formulation which, when applied, would become vulcanized, hardened and stabilized during application. The present invention provides such a system.

### SUMMARY

The present invention is a nitrile rubber based sealant system that has excellent storage ability in dry form and which can be cured (vulcanized) as needed under and with the aid of varying field conditions. Such a system is ideal for use in sealing leaking pipes and equipment in place and without the need to suspend operations. The invention is a superior leak seal suitable for sealing leaks in pipes, fittings, flanges and other structures made by heating delayed self curing nitrile rubber formulation comprised of a critically selected combination of components including specially preconditioned nitrile rubber, sulfur, accelerants, activators, fillers, plasticizers, flame retardant, antidegradant, metallic filaments and optionally nanophase rare earth material. The balanced proportions of these components provides a delayed curing composition that is stable at ambient conditions, easily formable into convenient and useable shapes, stores well and can readily used in the field. In use the composition is injected (extruded) into heated molds, where it is vulcanized (cured) without further additives, to form a hard, strong, durable chemical resistant seal that can be used to seal leaking pipes and structures without interruptions of flow or shut down of operations. The formulation has the advantage of wide temperature adaptability, wide medium resistance, injection manufacturability with excellent filling quality and sealing ability.

### DETAILED DESCRIPTION

The present invention is a cured or vulcanized nitrile rubber molded seal made from a delayed curing or vulcanizing formulation or composition. Molded seals are formed upon heating a delayed curing composition in a suitable mold. The composition comprises critical components formulated into dry un-reacted malleable form that cure or vulcanize when the dry un-reacted components are subjected to an effective amount of heat at an effective temperature. More specifically, the invention is a molded part or seal, such as a pipe sleeve, in which a specially preconditioned nitrile rubber composition, comprising sulfur and sulfur compounds for vulcanization, accelerants and activators, fillers, flame retardants and plasticizers, is forced by extrusion into a mold placed around the pipe, pipe fitting or industrial structure and subjected to effective heat and temperature to initiate curing (vulcanization), allowing the composition to irreversibly cure and harden by crosslinking the nitrile rubber polymer strands.

Vulcanization or curing is the irreversible reaction of the nitrile copolymer with sulfur or other crosslink compounds to provide cross links between the polymer strands and results in a more rigid hardened permanently formed product. A broad range of sulfur compounds may be used for vulcanization including hydrogen sulfide, sulfur oxides and the like as will be recognized by those skilled in the art. However, elemental sulfur is easily available and inexpensive but is somewhat slower to react than some other sulfur supplying compounds. But, elemental sulfur is an essential component of the composition of this invention. In a preferred embodiment the delayed curing formulation will contain about 0.3 to 0.5% sulfur.

Thus, this invention employs a low sulfur vulcanizing system with high efficiency that adjusts to constantly changing conditions throughout the entire injection (extrusion) process into a mold. This will optimize temperature adaptability. Additionally, it provides a delayed curing sealant that is stable at ambient conditions, easily stored and packaged, have excellent liquidity as well as formability (malleability) to meet the stringent technical requirement for use as a sealant. This composition will establish an efficient seal structure during initial injection, ductility dip, and transformation (vulcanization) to elastomer.

By judicious selection of the components the composition of this invention maximizes the functions of the vulcanized seal system to enable a wide temperature adaptability of −195 to 900° C. The composition has the advantages of wide medium resistance, injection manufacturability, excellent filling quality and sealing ability. By critical selection of base materials and accessory ingredients, this invention enhances the delayed curing composition's cross linking density in the vulcanization process, improves its physical and mechanical properties and strengthens its temperature adaptability. At the initial stage of injection into a heated mold, the formulations have a high degree of liquidity and formability that make it easy for the sealant to fill the entire mold cavity, avoiding the existence of dead angles and ensuring a long-term sealing stability.

The delayed curing compositions and the articles made from them are resistant to a broad range of fluids including oil, gas, coal gas, chemicals like benzene, aldehydes, alcohol, ketones, ester sand derivatives, acids, alkali and steam.

As the term is used herein nitrile rubber is a copolymer of acrylonitrile and butadiene and is usually produced by polymerized in an aqueous emulsion. The nitrile copolymer has single unit molecules linked into large multiple unit molecules. Higher acrylonitrile content gives the copolymer more strength and greater resistance to oil degradation and swelling. Generally, the nitrile rubber useful in this invention will contain (or be made from) about 20 to 70% acrylonitrile and more preferably about 30 to 50% acrylonitrile. It is partially elastic and sufficiently plastic to be easily formed or molded. A convenient form is an extruded cylinder sized to fit into specially designed extrusion guns for injection the formulation into a heated mold.

A key feature of the delayed curing composition of this invention is the proper preconditioning of the raw nitrile rubber prior to formulation with the other components. Preconditioned rubber means raw nitrile rubber that has been milled in an open mill having opposing rollers and exposed to ambient air for a period of about 16 to 24 hours. This treatment may also be termed plastication. This preconditioning reduces molecular cohesion, decrease elasticity and increase plasticity. The high molecular weight of rubber is reduced during milling so that even light plastication can reduce the molecular weight to one-tenth its initial level.

It is preferred that the milling rollers be spaced apart about 0.5 to 0 1.5 mm to obtain the best effect. The rubber is milled and mixed in a “Two Roll Mill” that has two opposing rollers (12 inch diameter). The milling processing time for this precondition step takes about 20 minutes on average. Therefore “Preconditioning” as the term is used herein and in the claims in reference to nitrile rubber means the plastication treatment described above.

Vulcanization (or curing) accelerators are needed for adequate curing since sulfur alone does not cross link very rapidly. Generally a package of accelerators and activators are needed to modify the kinetics of crosslinking and achieve commercially suitable curing. Additives also aid in stabilization of the cured product. Very suitable accelerants for the composition of the present invention include n-cyclohexy-2-benzothizole-sultenamide, 2-mercaptobenzothiazole and 2-dibenzothiazole disulfide.

Fillers are used to achieve the unique properties of the composition of this invention. Suitable fillers for the present invention include iron oxide red, talcum powder, graphite, semi-reinforcing furnace black, clay and carbon fiber.

Plasticizers such as dioctyl phthalate (and other phthalate compounds know in the art) are also used to improve plasticity and make the formulation more malleable and suitable for extrusion.

Additionally, flame retardants such as diantimony trioxide and chlorcosane are also used in the formulation to prevent flaming and/or burning at high operating temperatures.

Since the cured rubber maybe degraded by heat, oxygen and ozone, antidegradants are also used. A rare earth nanophase material is optional but also preferred as a component in the composition. The nanophase material capitalizes on its characteristic of small diameter and active nature in crosslinking. Consequently, the temperature adaptability, leak medium resistance and mechanical performance of the sealant are significantly improved. Because of the small size of the nanometer material, the extruded composition will help overcome space resistance to produce good dispersion and resistance to exposure degradation. Additionally, the chemically active rare-earth element facilitates the cross-linking effect in the process of vulcanization, which strengthens the inhibitory molecules' conformational change, better stabilizes the sealing structure and improves the temperature adaptability, medium resistance and mechanical performance of the seal. As a result of the compacting effect of injection process, the injected composition prevents penetration by the leaking medium. The linked reactive groups form stable bonds that will not chemically react with nor be eroded by the leaking medium. Thus the nanophase material extends the compositions adaptability under various working conditions.

A very suitable rare earth material is neodymium.

The preferred filament in the formulation is flexible metallic wire including brass, copper, aluminum, lead or zinc. Steel wire may be used but is generally too stiff to be included into an extrudable sealant. Polymer filaments may also be used but generally must be selected with careful consideration of the curing and use conditions—those that melt or become too flexable at operating temperature are not suitable. In general, nylon and similar materials may be useful if the operating temperature is relatively low. The metal filaments will generally be about 5 mm to 15 mm in length and 0.3-0.5 mm diameter. If the filament is too short it will not provide sufficient strength to the final vulcanized material to be useful and if too long will not be extrudable in applications where it is used as an extrudable pipe leak sealant or other applications where the dry un-reacted is injected or extruded into place.

Typically the compositions of the invention will harden from about 40 Shore A to about 70 to 80 Shore A when cured. For example, one formulation having low sulfur, iron oxide and talcum powder fillers will harden from about 40 Shore A to about 69 Shore A after heating at 150° C. for 30 minutes. Another formulation having higher sulfur content and graphite filler hardens from about 40 Shore A to about 80 Shore A on heating for 30 minutes at 302 F.

Tensile strength of the compositions of the invention are about 0.7 Mpa (under ambient condition) and inv crease to about 4.3 after heating at 150° C. for 30 minute.

In sum, the delayed curing compositions of this invention will comprise, by weight: 10-20% preconditioned acycronile-butadene rubber; 0.3 to 0.5% sulfur; 6 to 12% crosslinking compounds and fire retardant agents selected from the group consisting of diantimony trioxide, and chlorcosane; 1 to 6% accelerant selected from the group consisting of n-cyclohexyl-2-benzothizole-sultenamide, 2-mercaptobenzothiazole and 2-dibenzothiazole disulfide or a combination thereof; 3 to 8% zinc oxide and/or stearic acid activators; 50 to 60% total fillers selected from the group consisting of iron oxide, talcum powder, graphite, semi-reinforcing carbon black, clay and combinations thereof; 10 to 20% plasticizer; 0-2% rare earth nanophase material; 2 to 5% antidegradant; and 2 to 5% metallic filament.

Table 1 shows the curing time needed for complete vulcanization (curing) of illustrative compositions of this invention. These compositions generally reflect the time needed in the mold to provide a proper seal. Composition A (a composition of this invention) in Table 1 is a composition as described above with 0.2% sulfur and iron oxide and talcum powder as fillers. Composition B substitutes graphite for the iron oxide and talcum powder and has higher sulfur content.

TABLE 1
Temperature and delayed curing composition curing time

| | Composition A | Composition B |
|---|---|---|
| Temperature ° C. | Curing Time, Min. | Curing Time, Min. |
| 150 | 110 | 150 |
| 200 | 54 | 86 |
| 250 | 31 | 40.5 |
| 300 | 17 | 24.5 |
| 350 | 11 | 15 |

During curing the composition will lose weight as organics are driven off—the amount of weight loss depending upon the temperature of curing. This weight loss is illustrated for composition A in the following Table 2.

TABLE 2

| Temperature ° C. | Weight Loss-% of Original |
|---|---|
| 250 | 4.31 |
| 350 | 13.18 |
| 450 | 21.55 |
| 500 | 26.68 |
| 600 | 29.67 |
| 700 | 32.33 |
| 791.5 | 35.04 |

### Molds

The seal of this invention is intended, in preferred embodiments, to be molded around a pipe, pipe fitting, elbow, tee, flange and the like. The delayed curing rubber composition, because of its unique combination of components, has remarkable sealing properties that allow it to be extruded into suitable molds, withstand the deleterious effect of almost any leaking medium and allow application over a wide range of conditions. Of course, molds of any type may be used to provide molded articles from the delayed curing rubber composition of this invention, but the optimum utility is found in providing seals for leaking pipes and equipment during operation without the necessity to terminate operations or medium flow for repairs.

Suitable molds are made of metal, preferably steel, that are constructed with sufficient strength to withstand the pressure of the extruded rubber compound and the pressure inside the mold resulting from leaking medium. The mold will generally be a removable or detachable structure constructed to provide a tight seal around the pipe at the ends of the mold leaving a sealed annular chamber in the midsection of the mold. For example, a steel mild for providing a seal around a leaking pipe will be constructed as two hemispheres with flanged sides that mate and can be fastened around the pipe by bolting or clamping the flanges together. The mold will have a longitudinal center section slighter larger than the outside diameter of the pipe to form an annular space. The longitudinal ends will be approximately the diameter of the pipe (and may have graphite bushings) to seal the annular space to prevent delayed curing composition from escaping during the molding operation. The mold will have at least two ports into which a delayed curing rubber compound can be injected. In some embodiments, depending on the size of the mold, there may be as many as eight to ten ports disposed around the circumference of the mold. The ports are smaller in diameter than the shaped sealant composition to be injected in it. In general, the ports will be large enough to allow extrusion of the dry malleable delayed curing composition but not so large as to allow the partially liquefied composition to easily flow back out of the mold. For example, in one embodiment, the composition will be shaped into extruded cylinders of about 20 mm diameter and about 90 mm long. The mold ports will be about 5-15 mm diameter and preferably 8-10 mm. Other diameters and lengths may also be used as determined by convenience, mold and injection means size and the like.

The metal molds are made or adapted for use on various areas of piping and equipment, including leaking pipes, elbows, tees, flanges, valves and other equipment areas where leaks occur. In the case of other shapes, as will be appreciated, the annular space and mold seal ends will be similar to that described above for a pipe mold but adapted to the shape of the area on to which it is to be fitted. Before extrusion and curing the sealant is somewhat plastic and malleable but not sticky. It will become generally become semi-liquid as it flows into a heated mold.

The effective leak seal of the invention in formed by extruding the delayed curing composition into a mold. The specially designed mold, as described above, is placed over the pipe, pipe fitting, flange or other part to be sealed. The mold provides an annular space around the pipe into which the delayed curing composition will be injected by extruding into the mold through ports in the mold. It is preferred that the annular space be from about 5 m to 20 mm in width (from outside diameter of the pipe to inside surface of the mold. It will be appreciated that for the more complex molds the size of the annular space will vary but the 5 mm to 20 mm width should generally be applicable at the site of the leak. Molds around flanges, where the entire gap between the flanges is sealed with a will necessarily have an annular space the width of the space between the inside flange faces.

To inject the delayed curing composition into a mold, it is preferred to use an injection gun designed to extrude the delayed cure composition. An injection gun from which a cylinder of delayed curing composition is extruded into a mold may be powered by a high pressure pump, preferably a hand pump to prevent any sparks in the vicinity of an industrial leak or by any other suitable means. If the mold is heated, as it would be if the medium in the pipe was heated, the composition will soften and, if the temperature is sufficiently high will partially liquefy, as it moves into the mold. Partial liquefaction hastens curing and allows the composition to more easily fill the mold.

To complete the seal the extruded delayed rubber composition will be heated (which may be effected by heat of the pipe) for sufficient time to cause the composition to cure (vulcanized). The time will depend upon the temperature as shown in Table 1. As can be seen, for the delayed curing composition of this invention the temperature will be at least 80° C. to accomplish a cure in any reasonable time. At higher temperatures the cure will be much faster. The composition will form a tight molded to temperature as high as 800° C. Since curing is not initiated below 80° C. the composition remains stable at ambient conditions and can easily be stored.

At the initial stage of injection into the mold, the composition has a high degree of liquidity and formability that make it easy for the composition to fill the entire mold cavity, avoiding the existence of dead angles and ensuring a long-term sealing stability. This excellent liquidity and formability in the initial injection stage allows the composition to fill in every corner of the mold cavity. The design of the molds, the properties of the delayed curing composition and staged injection (as explained below) will prevent the composition from entering the leaking media stream and therefore not contaminate the media, but will solidify as it fully fills the entire cavity space, building a structure around pipe, fitting, valve or flange.

The mold annular space is filled by injecting the delayed curing composition into ports in the mold. Staged injection is very important to obtain a good seal. The composition is first injected into a port opposite or well away from the point of the leak. As the first injections fills the section of the mold adjacent the injection port additional composition is injected into ports nearer the leak. Lastly, composition is injected into a port nearest the leak—the unfilled cavity at the point being relatively small so as to not allow the leaking medium space to mix with or contaminate the injected composition. As explained above smaller port diameter compared to the shaped composition size helps hold the composition in the mold until it is sufficiently cured and hardened to not flow back through the port. As the annular cavity is filled, from a point away from the leak and sequentially around to the leak point the injected composition has the anti-tensile and tear-resistance strength to withstand the pressure of the leaking medium's ejection. This helps to avoid being dispersed and sprayed; after being compacted and solidified, the seal holds sufficient load bearing ability to ensure that the operational success rate reaches almost 100%.

Metallic filaments in the composition provide a wide range of adaptability to temperature and pressure. Where the gap between a mold and the leakage is large, the filament helps prevent the composition from coming out of the mold port.

In the foregoing specification, the invention has been described with reference to specific embodiments thereof. It will, however, be evident that various modifications and changes can be made thereto without departing from the broader spirit and scope of the invention as set forth in the appended claims. The specification is, accordingly, to be regarded in an illustrative rather than a restrictive sense. Therefore, the scope of the invention should be limited only by the appended claims.

1. A molded nitrile rubber seal formed by placing a delayed curing nitrile rubber composition comprising a preconditioned nitrile rubber, sulfur, a sulfur compound capable of cross linking the nitrile rubber, an accelerant, an activator, a filler, a plasticizer, a flame retardant and metallic filament, all compounded in dry un-reacted form, into a mold and applying heat to effect vulcanization of the nitrile rubber.

2. The seal of claim 1 wherein the initial nitrile rubber is derived from the polymerization of acylonitrile and butadiene wherein the butadiene content is from 50 to 70 percent and the acylonitrile content is form 30 to 50 percent.

3. The seal of claim 1 wherein the nitrile rubber is preconditioned by milling and exposure to air for sufficient time to increase plasticity sufficiently to be easily extrudable into a mold.

4. The seal of claim 3 wherein the preconditioning is conducted in a mill having rollers spaced about 0.5 to 1.5 mm apart and the nitrile rubber is exposed to ambient condition for about 18 to 26 hours before mixing with other components.

5. The seal of claim 1 wherein the accelerant is selected from the group consisting of n-clyclohexyl-2-benzothizole-sulfenamide, 2-Mercaptobenzothiazole and 2-2-dibenzothiazole disulfide, and combinations thereof and the activator is selected from the group consisting of zinc oxide and stearic acid and mixtures thereof.

6. The seal of claim 1 wherein the filler is selected from the group consisting of iron oxide red, talcum powder, graphite, semi-reinforcing furnace black and clay, the plasticizer is dioctyl phthalate and the flame retardant is selected from the group consisting of diantimony trioxide and chlorcosane.

7. The seal of claim 1 wherein there is also added a nanophase rare earth compound as a cross-linking agent.

8. The seal of claim 7 wherein the rare earth compound is neodymium.

9. The seal of claim 1 wherein the metallic filament is brass, copper, aluminum, lead or zinc or a combination thereof.

10. The seal of claim 1 wherein the delayed curing nitrile rubber composition is comprised of: a preconditioned nitrile rubber, sulfur, a sulfur compound capable of cross linking the nitrile rubber, an accelerant, an activator, a filler, a plasticizer, a flame retardant and metallic filament filler all compounded in dry un-reacted form, that reacts to become cured or vulcanized when heated above, said delayed curing nitrile rubber composition being compounded of nitrile rubber that is preconditioned by open milling and exposed to ambient conditions for sufficient time to reduce elasticity and increase plasticity sufficiently to allow extrusion into a mold, to which is added in a mixer in the sequence:
sulfur, sulfur compounds, flame retardants and accelerants;
activators;
fillers;
plastizer; and
rare earth nanophase material and antidegradants, if any; and
mix thoroughly and form into suitable shape for future use

11. A method for making a vulcanized nitrile rubber seal comprising confining a delayed curing nitrile rubber composition comprising a nitrile rubber, a sulfur compound capable of cross linking the nitrile rubber, an accelerant, an activator, a filler, a plasticizer, a flame retardant and metallic filament all compounded in dry un-reacted form, into a mold placed around the article to be sealed and heating for sufficient time effect vulcanization to produce a hardened cured rubber article.

12. The method of claim 11 wherein the mold is an annular space surrounding a heated leaking pipe formed by placing a metal detachable mold having an inside diameter greater than the outside diameter of the pipe, said having at least two injection ports for into which are extruded the delayed curing rubber composition.

13. The method of claim 11 wherein the heated pipe is at least 80° C.

14. The method of claim 12 wherein the annular surround a leaking pipe and the dry un-reacted nitrile rubber is injected in stages beginning at a point away from the from the leak to fill the annular space and in which the vulcanized rubber compound seals the leak in the pipe.

15. An extrudable delayed curing nitrile rubber composition comprising a nitrile rubber, a sulfur compound capable of cross linking the nitrile rubber, an accelerant, an activator, a filler, a plasticizer, a flame retardant and metallic filament all compounded in dry un-reacted form and wherein the nitrile rubber is in the composition is preconditioned for sufficient to increase plasticity prior to compounding with the other components of the composition.

16. The composition of claim 15 wherein the composition also comprises a nanophase crosslinking agent.

17. The composition of claim 15 wherein the sulfur compound is sulfur, the accelerant is selected from the group consisting of n-cyclohexyl-2-benzothizole-sultenamide, 2-2 Mercaptobenzothiazole and 2-dibenzothiazole disulfide or a combination or a combination thereof, the activator selected from a group consisting of zinc oxide and stearic acid or a combination thereof, the filler is selected from the group consisting of iron oxide red, talcum powder, graphite, semi-reinforcing furnace black and clay, the plasticizer is dioctyl phthalate and the flame retardant is selected from the group consisting of diantimony trioxide and chlorcosane.

18. The composition of claim 17 comprising, by weight: 10-20% preconditioned acycronile-butadene rubber; 0.3 to 0.5% sulfur; 6 to 12% crosslinking compounds and fire retardant agents selected from the group consisting of diantimony trioxide, and chlorcosane; 1 to 6% accelerant selected from the group consisting of n-cyclohexyl-2-benzothizole-sultenamide, 2-mercaptobenzothiazole and 2-dibenzothiazole disulfide or a combination thereof; 3 to 8% zinc oxide and/or stearic acid activators; 50 to 60% total fillers selected from the group consisting of iron oxide, talcum powder, graphite, semi-reinforcing carbon black, clay, and combinations thereof; 10 to 20% plasticizer; 0-2% rare earth nanophase material; 2 to 5% antidegradant; and 2 to 5% metallic filament.
